(19) United States
(12) Patent Application Publication
(10) Pub. No.: US 2009/0200960 A1
(43) Pub. Date: Aug. 13, 2009

(54) Methods and Apparatus for Self-Starting Dimmable Ballasts With A High Power Factor

(75) Inventor: Ray J. King, Carolina Beach, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Pure Spectrum, Inc., Savannah, GA (US)

(21) Appl. No.: 12/187,139

(22) Filed: Aug. 6, 2008

Related U.S. Application Data
(63) Continuation-in-part of application No. 12/178,317, filed on Jul. 23, 2008.
Application No. 12/178,317 is a continuation-in-part of application No. 12/178,397, filed on Jul. 23, 2008.
(60) Provisional application No. 61/006,965, filed on Feb. 8, 2008.
(60) Provisional application No. 61/006,965, filed on Feb. 8, 2008.

(51) Int. Cl. H05B 41/36

(52) U.S. Cl. 315/291

(57) ABSTRACT

Methods and apparatus for self-starting dimmable ballast circuits are disclosed. In the described examples, a dimmable ballast circuit includes a rectifier, an energy storage device, a driver circuit, and a resonant circuit that are configured to actuate the light source such as a fluorescent lamp. The power source is coupled to the light source via a single resonant circuit that includes power factor correction therein. Further, the resonant circuit is selectively configured to start the light source without requiring a separate starter circuit. Further, energy storage device is a capacitor that stores high frequency energy and continually recycles energy in the circuit, resulting in a circuit with a large power factor. Because the current flowing in the circuit is substantially sinusoidal, the described examples generally have an ideal power factor.

### RELATED APPLICATIONS

This application claims the benefit under 35 U.S.C. §120 as a continuation-in-part of U.S. Patent Application entitled “Methods and Apparatus for Dimmable Ballasts with a High Power Factor” filed on Jul. 23, 2008, bearing Ser. No. 12/178,397, which further claims the benefit under 35 U.S.C. §119(e) to U.S. Provisional Patent Application entitled “Dimmable Ballast with High Power Factor” filed on Feb. 8, 2008, bearing Ser. No. 61/006,965. Both of the patent applications are herein incorporated by reference for all that they teach.

### FIELD OF THE DISCLOSURE

The present disclosure relates generally to electronic lighting ballasts and, more particularly, to methods and apparatus for self-starting dimmable ballasts with high a power factor.

### SUMMARY OF THE INVENTION

Methods and apparatus for self-starting, dimmable ballast circuits are disclosed. A self-starting dimmable ballast circuit in accordance with one or more embodiments of the invention includes a power source coupled to a first node and a second node, the power source having a current that alternates at a line frequency and a first voltage. The first node and the second node are coupled to each other via an energy storage device that stores energy at a first frequency that exceeds the line frequency of the power source. A first switch is operable to selectively couple the energy storage device to a resonant circuit via the first node. The resonant circuit has a resonant frequency and stores energy during a first portion of a cycle of the first frequency. A second switch is operable to selectively couple the energy storage device to a resonant circuit via the second node to cause energy stored in the resonant circuit to be substantially stored in the energy storage device during a second portion of the cycle of the first frequency. In addition, the resonant circuit is selectively operable to increase the first voltage to a higher second voltage during a first portion of a cycle of the line frequency.

### BACKGROUND

In the field of light sources (e.g., gas discharge lamps, fluorescent lamps, light emitting diodes, etc.), the light sources generally present a negative resistance that causes the power source to increase the amount of electrical current provided. To limit the current, a ballast circuit is typically provided that limits the amount of current provided to the light source. FIG. 1 illustrates a conventional ballast circuit with a high power factor and includes a high power factor correction circuit. However, such power factor correction circuits generally have poor efficiency caused by losses due to a power transistor and a power diode and increases costs of the ballasts due to additional circuitry required. As a result, such ballast circuits typically have poor efficiency and increase the number of components used in a conventional power factor correction ballast. Further, such ballast circuits generally include a large, high voltage, low temperature electrolytic capacitor that substantially limits its corresponding lifespan and temperature rating.

### BRIEF DESCRIPTION OF THE DRAWINGS

FIG. 1 illustrates a conventional ballast having a high power factor correction circuit.

FIG. 2 illustrates a block diagram of an example self-starting ballast circuit having a high power factor in accordance with the present invention.

FIG. 3 is a flow diagram of a process that the example ballast circuit of FIG. 2 may implement.

FIG. 4 is a schematic diagram of an example circuit that may implement the example process of FIG. 3.

FIG. 5 illustrates is a voltage waveform diagram that illustrates the operation of an exemplary rectifier of the circuit of FIG. 4.

FIG. 6 is a voltage waveform diagram that illustrates the operation of an exemplary regulator of the circuit of FIG. 4.

FIG. 7 is an equivalent circuit that illustrates the operation of the example circuit of FIG. 4.

FIG. 8 is a voltage waveform diagram that illustrates the operation of the equivalent circuit of FIG. 7.

FIGS. 9 and 10 are equivalent circuits that illustrate the operation of the example circuit of FIG. 4.

FIG. 11 is a voltage waveform diagram that illustrates the voltage at the resonant circuit of FIG. 4.

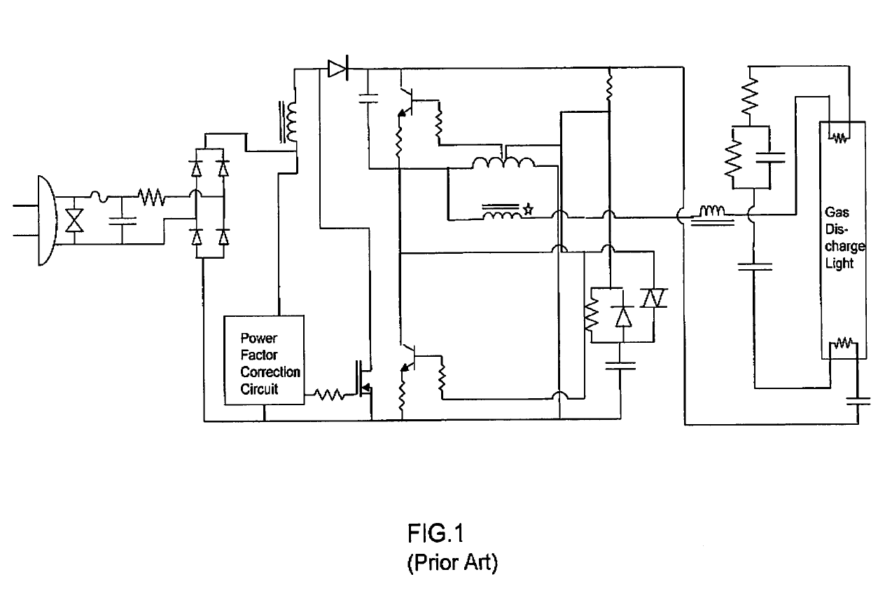

### DETAILED DESCRIPTION OF EXEMPLARY EMBODIMENTS OF THE INVENTION

Methods and apparatus for self-starting dimmable ballasts with a high power factor are described herein. In the described examples, a self-starting dimmable ballast circuit having a high power factor directly interfaces a power source with a light source (e.g., with or without filaments) via a single resonant circuit. In addition, the described dimmable ballasts include a high frequency bypass capacitor to recycle high frequency energy during its operation to increase efficiency. Further, coupled inductors are implemented into a loop to boost a voltage and start the operation of the light source without requiring a separate starter circuit. Due to the operation of the high frequency bypass capacitor and the inductors in the loop, the described examples achieve a high power factor (e.g., 0.7-0.99) and a high efficiency (90-99%).

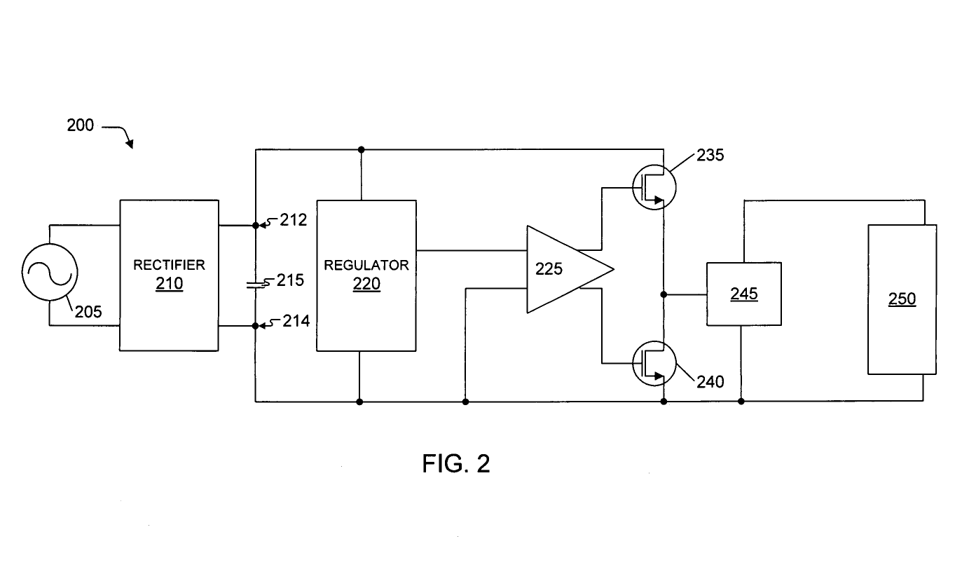

FIG. 2 illustrates a block diagram of an example ballast circuit 200 configured to have a high power factor and high efficiency. Typically, circuits having a power factor approximately in the range of 0.9-0.99 are generally considered to have a high power factor, which is typically provided by a separate power factor correction circuit. In particular, exemplary ballast circuit 200 includes a high power factor correction that is performed in a single stage of impedance transformation, thereby eliminating the need for such separate power factor correction circuits while retaining substantially the same functionality. Further, exemplary ballast circuit 200 includes an operation to start the light source every cycle of a line frequency, thereby allowing it to have a high efficiency without requiring a separate starting circuit.

In the example of FIG. 2, the ballast 200 includes a power source 205 that is coupled to a rectifier 210. The power source 205 is typically an alternating current source that provides a line current having a magnitude that alternates at a line frequency (e.g., 60 hertz (Hz)). Rectifier 210 is typically a full-wave rectifier that substantially inverts the negative magnitude of the current provided via the power source 205, thereby doubling the line frequency of the line current (e.g., to 120 Hz). Rectifier 210 conveys the rectified current onto a first node 212 and receives current from a second node 214.

Nodes 212 and 214 are coupled via a high frequency energy storage device, such as a capacitor 215. In the example of FIG. 2, the capacitance value of capacitor 215 is selected to have a value such that it presents a large impedance to the rectified current (i.e., the line frequency), thereby not substantially affecting the rectified current provided via rectifier 210. More particularly, the capacitance value of capacitor 215 in the example of FIG. 2 is selected to store high frequency energy, generally in the kilohertz (KHz) range. As such, capacitor 215 in the example of FIG. 2 has value of approximately 0.1 to 3 microfarads (μf) and is made of any suitable material (e.g., polypropylene, etc.) for a ballast having a power output of approximately 25 watts. In other examples, capacitor 215 may have a value of approximately 1 to 30 μf for a ballast having a power output of approximately 250 watts. That is, capacitor 215 generally has a capacitance value in the range of 4 to 120 nanofarads (nf) per watt of power. In the illustrated example, capacitor 215 is a polypropylene capacitor that has a longer lifespan and a higher temperature rating compared to larger electrolytic capacitors that are used in conventional ballasts.

Ballast circuit 200 also includes a regulator 220 coupled to nodes 212 and 214. Regulator 220 generates a substantially constant voltage that exceeds a first threshold (e.g., 10 volts, etc.) to provide power to a driver 225. In the illustrated example, driver 225 is configured to alternately actuate one of a first transistor 235 and a second transistor 240 at a carrier frequency. Exemplary transistors 235 and 240 are both implemented using vertical N-Channel metal oxide semiconductor (NMOS) field effect transistors. Of course, one of ordinary skill in the art would know that transistors 235 and 240 can be implemented by any suitable device (e.g., a P-channel metal oxide field effect transistor, an insulated gate bipolar transistor (IGBT), a lateral N-channel depletion mode MOS transistor, a bipolar transistors, a thyrsistor, etc.).

Driver 225 and transistors 235 and 240 form a half-bridge topology that is implemented to cause a resonant circuit 245 to power a light source 250 in the illustrated example. To form the half-bridge topology, the drain of transistor 235 is coupled to node 212 and the source of transistor 240 is coupled to node 214. The gates of transistors 235 and 240 are both coupled to driver 225, which alternately actuates one of transistors 235 and 240. Further, the source of transistor 235 is coupled to the drain of transistor 240, both of which are also coupled to resonant circuit 245. In addition, resonant circuit 245 has a resonant frequency (e.g., 20 KHz, etc.) and is also coupled to node 214 and light source 250 (e.g., a gas discharge lamp, a fluorescent lamp, a light emitting diode (LED), a high intensity discharge (HID), etc.). As will be described in detail below, resonant circuit 245 stores energy and selectively charges and discharges energy into light source 250 at a frequency that exceeds the line frequency of the rectified current, thereby exciting light source 250 to visually emit light. Further, the resonant circuit 245 presents an impedance to power source 205 to thereby limit the current flowing into light source 250.

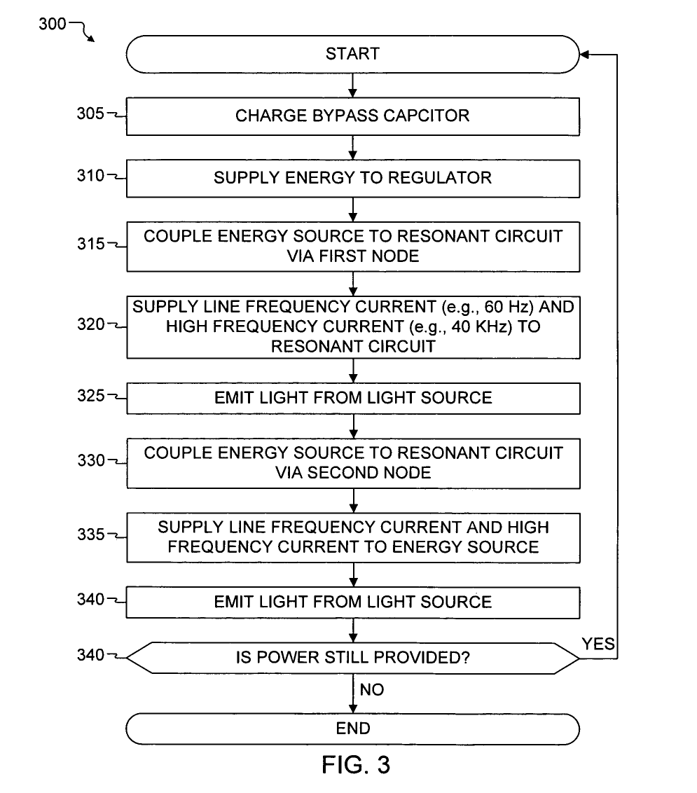

FIG. 3 illustrates an exemplary process 300 that ballast circuit 200 may implement when coupled to a power source (e.g., a alternating current source, etc.). If power is provided to the ballast, exemplary process 300 begins by charging a high frequency bypass capacitor (block 305). Specifically, the bypass capacitor presents a large impedance to a line frequency current of the power source having a low frequency current (e.g., 60 Hz, 120 Hz, etc.) (block 310). In addition, exemplary process 300 supplies energy to charge a regulator that provides power to actuate a driver circuit, for example (block 310). In the example of FIG. 3, exemplary process 300 couples the energy source (e.g., a power supply, etc.) and the bypass capacitor to a resonant circuit via a first node (block 315). In response, the energy source supplies the line frequency current and a high frequency current (e.g., 40 KHz) to the resonant circuit (block 320). In particular, the bypass capacitor provides the high frequency current via the first node. When the resonant circuit receives the line frequency current and the high frequency current, the resonant circuit has a voltage with a positive magnitude, thereby causing a light source coupled to the resonant circuit to emit light therefrom (block 325).

After emitting light from the light source, exemplary process 300 then couples the resonant circuit to the energy source via a second node (block 330), which supplies the line frequency current and the high frequency current to the energy source (block 335). As a result, the resonant circuit has a voltage with a negative magnitude, thereby causing the light source coupled to emit light therefrom (block 340). Exemplary process 300 determines if power is still provided by the energy source (block 345). If power is provided, exemplary process 300 returns to block 305. On the other hand, if power is not provided to the ballast, exemplary process ends.

In example of FIG. 3, the high frequency current in exemplary process 300 is stored in the bypass capacitor, thereby continually recycling the high frequency energy during its operation. In some examples, the high frequency current has a frequency generally in the range of approximately 20 to 80 KHz. Thus, according to exemplary process 300, the high frequency current continually recycles via the bypass capacitor, thereby preventing substantial energy loss. Further, the energy source is directly coupled to the resonant circuit via a low impedance path to prevent substantial loss of energy. Accordingly, the resulting circuit implementing such a process generally has a power factor approximately in the range of 0.7-0.99, a high efficiency, and an ideal crest factor. In the described examples, the value of the components (e.g., capacitance, tapped and gapped inductance, etc.) can be selected such that the power factor exceeds a value of 0.9.

FIG. 4 is a schematic diagram of an exemplary circuit 400 that may implement exemplary process 300 (FIG. 3). In the example of FIG. 4, a power source 402 is coupled to rectifier 210 via a line filter 404, which insulates power source 402 from noise due (e.g., electromagnetic interference, etc.) generated by the balance of exemplary circuit 400. More particularly, a first terminal 406 of power source 402 is coupled to the anode of a diode 408 and the cathode of a diode 410 via line filter 404. Further, a second terminal 412 of power source 402 is coupled to the anode of a diode 414 and the cathode of a diode 416 via the line filter 405. The cathodes of diodes 408 and 414 are coupled to a first node 418 and the anode of diodes 410 and 416 are coupled to a second node 420. In the illustrated example, nodes 418 and 420 are coupled to each other via a capacitor 422, which operates as a low impedance to high frequency energy and a high impedance to a low frequency energy.

Regulator 220 is also coupled to nodes 418 and 420 and is configured to provide a substantially constant voltage. In the illustrated example, regulator 220 is implemented using transistor 424 with its respective drain coupled to node 418 via a resistor 426. The drain of transistor 424 is coupled to its respective gate via a resistor 426. The gate of transistor 424 is further coupled to the collector of a transistor 430, which has its respective base coupled to the anode of a zener diode 432. The cathode of zener diode 432 is coupled to the source of transistor 424. In addition, the base of transistor 430 is coupled to node 420 via resistor 434 and its emitter is coupled to node 420 via a resistor 436. In the example of FIG. 4, the source of transistor 424 is coupled to the cathode of a diode 438, which has its respective anode coupled to node 420 via an energy storage device, such as a capacitor 440, for example. As will be described below, capacitor 440 stores energy therein to provide a substantially constant voltage to driver 225.

In the illustrated example of FIG. 4, driver 225 is implemented using any suitable circuit that selectively actuates transistors 235 and 240. In the example of FIG. 4, driver 225 includes, for example, an International Rectifier™ 2153, which is a self-oscillating half-bridge driver circuit 442. However, one of ordinary skill in the art would understand that any suitable circuit could be implemented to perform the functions that driver 225 provides (e.g., a 555 timer, a 555 timer with a gate drive transformer, etc.). In other examples, transistors 235 and 240 may be integral with the driver circuit 442 (e.g., a integrated circuit such as the STMicroelectronics™ L6574, etc.). In other examples, a square wave may be generated at a low voltage to drive a transformer (e.g., a two winding gate drive transformer, etc.) to attain the same function of driver 225.

Referring to the driver circuit 442, capacitor 440 provides the substantially constant (i.e., regulated) voltage via diode 438, which also isolates transistor 424 from driver circuit 442. Stated differently, diode 438 prevents current from flowing from capacitor 440 into node 418 when the voltage of node 418 falls below the voltage stored in capacitor 440. In the example of FIG. 4, capacitor 440 and the cathode of diode 438 are also coupled to the supply voltage (V_{CC}) of driver circuit 442 to provide a substantially constant voltage to driver circuit 442. The capacitor 440 and the cathode of diode 438 are also coupled to the anode of a diode 444, which is coupled to the high side floating supply voltage (V_{B}) of driver circuit 442 via its respective cathode. Further, the cathode of diode 444 is coupled the high side floating supply offset voltage (V_{S}) of driver circuit 442 via a capacitor 446 and node 420 is coupled to the IC power and signal ground (COM) of driver circuit 442.

In the illustrated example of FIG. 4, the frequency of driver circuit 442 is selected by presenting different impedances to driver circuit 442. More particularly, the oscillating timing capacitor input (C_{T}) of driver circuit 442 is coupled to node 420 via a capacitor 448. Further, the oscillator timing resistor input (R_{T}) of driver circuit 442 is coupled to the oscillating timing capacitor input (C_{T}) of driver circuit 442 via an adjustable resistor 450 (e.g., a potentiometer, a transistor presenting a variable resistance, etc.). In such a configuration, the carrier frequency of driver circuit 442 is variably controlled by adjusting the resistance of resistor 450, which is typically set during manufacturing, for example.

In the illustrated example, the resistance value of resistor 450 and the capacitance value of capacitor 448 configure driver circuit 442 to produce pulses at a frequency in the range of approximately 20 to 100 KHz. Specifically, low side pulses and high side pulses are alternately produced by driver circuit 442 and are output via the high side gate driver output (HO) and the low side gate driver output (LO), respectively. Stated differently, during the first half cycle of a period of the carrier frequency (i.e., the half of the time period for a single cycle), the high side gate driver output of the driver circuit 442 produces a high side pulse. During the second half cycle of the period (i.e., the low side of the cycle) of the carrier frequency, the low side gate driver output of the driver circuit 442 produces a low side pulse.

In the example of FIG. 4, the high side gate driver output (HO) is further coupled to the gate of a transistor 452 and the low side gate driver output (LO) is coupled to the gate of a transistor 454. In other examples, driver circuit 442 may be coupled to the gates of transistors 452 and 454 via resistors to prevent oscillations, for example. Transistors 452 and 454 are also coupled to the high voltage floating supply return (V_{S}) of the driver circuit 442 via their source and drain, respectively. The drain of transistor 452 is coupled to node 418 and the source of NMOS transistor 454 is coupled to node 420.

As described above, the source of the transistor 452 and the drain of transistor 454 are coupled to resonant circuit 245, which selectively stores a charge therein. In the illustrated example, the source of transistor 452 and the drain of transistor 454 are coupled to a node 456 of the resonant circuit via a capacitor 458 in series with an inductor 460. Exemplary inductor 460 is implemented by a primary winding of a gapped ferrite core, for example, and is capable of handling a large peak current. As will be described in detail, the primary winding of such a gapped ferrite core creates a high frequency resonant energy. Node 456 is coupled to node 420 via a capacitor 462 to store charge therein and excite a light source 464, which is coupled to node 456 via an inductor 466. In the illustrated example, inductor 466 is implemented by a secondary winding of the gapped ferrite coreand is coupled to a first end 468 of light source 464 and a second end 470 of light source 464 is coupled to node 420. As will be described in detail below, the secondary winding is configured to boost a voltage during a first portion of the line frequency. Further, such a gapped ferrite core includes an air gap to substantially prevent saturation when the resonant circuit 245 a current having the line frequency is substantially at its peak. In the illustrated example, capacitor 458, inductor 460, capacitor 462, and inductor 466 have a resonant frequency, thereby implementing the resonant circuit 245. In other examples, the resonant circuit 245 may include a series balancing cap (not shown) to balance the imperfections of the light source 464 and reduce flickering of the light source when dimming.

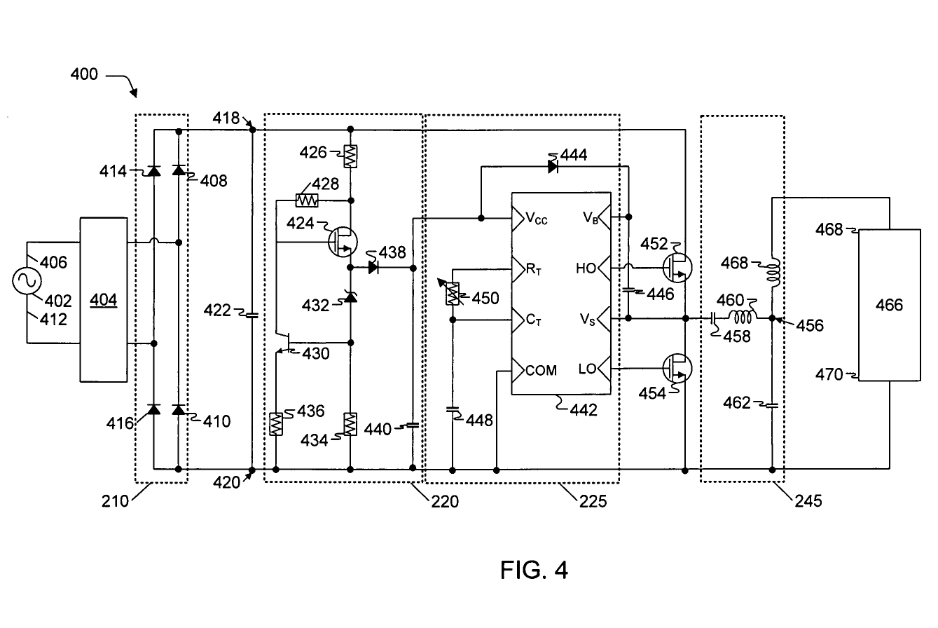

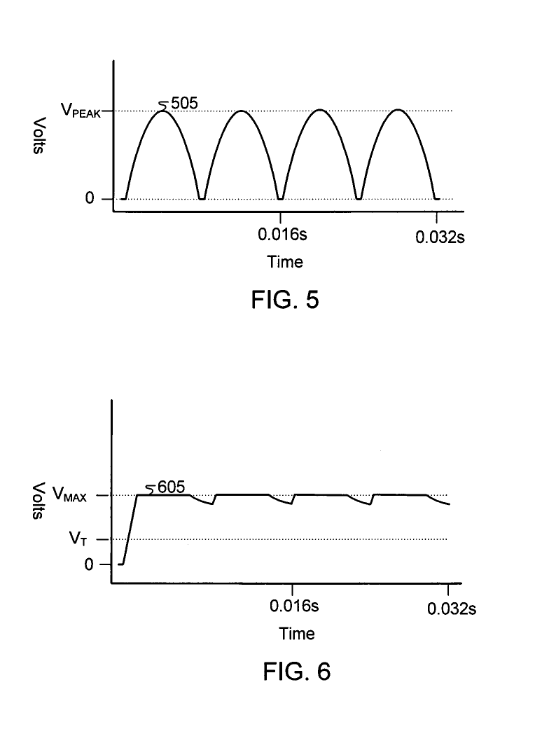

The operation of the example of FIG. 4 will be explained in conjunction with FIGS. 5-11, which illustrate the operation of exemplary circuit 400. As described above, diodes 408, 410, 414, and 416 rectify a current provided via power source 402. Typically, power source 402 provides a current that has a line frequency (e.g., 60 Hz, etc.) and the rectification doubles the line frequency. The exemplary waveform of FIG. 5 illustrates the voltage differential between nodes 418 and node 420, which is denoted by the reference numeral 505. In addition, capacitor 422 presents a large impedance to the current provided via power source 402 and, as a result, does not substantially affect the rectified current at nodes 418 and 420. In the example of FIG. 4, line filter 404 is configured to prevent high frequency energy associated with exemplary circuit 400 from entering power source 402.

As described above, regulator 220 provides a regulated voltage to driver 225. In the example of FIG. 4, resistor 428 causes transistor 424 to have a gate-source voltage and, in response, transistor 424 turns on to conduct current. In the illustrated example, a resistor 426 generally configures transistor 424 in the safe operating area. Specifically, in the event excessive current flows into the resistor 426, it experiences a catastrophic failure and uncouples transistor 424 from node 418. When current flows from the source of transistor 424, zener diode 432 blocks current from flowing into node 420 by presenting a large impedance, which causes the current to flow toward the gate drive supply voltage (V_{CC}) of driver circuit 442. When current flows toward the gate drive supply voltage, capacitor 440 stores the current as a voltage to provide a substantially constant voltage to driver circuit 442. As a result, driver circuit 442 turns on and produces pulses via its respective outputs at a frequency determined by the resistance value of adjustable resistor 450 and the capacitance value of capacitor 448.

However, when the voltage across zener diode 432 exceeds a corresponding breakdown voltage (e.g., −14.0 volts, etc.), zener diode 432 enters what is commonly referred to as the “avalanche breakdown mode” and allows current to flow from its cathode to its anode. In response, the current flows across resistor 434 and causes transistor 430 to have a base-emitter voltage (V_{BE}), thereby turning on transistor 430. Transistor 430 sinks current into node 420, which reduces the gate-source voltage of transistor 424 and the voltage across zener diode 432. Once the voltage across zener diode 432 does not exceed the breakdown voltage, zener diode 432 recovers from the excessive avalanche breakdown current and reduces the excessive current from flowing into resistor 434. That is, as illustrated in the example of FIG. 6, by reducing the voltage at the source of transistor 424 denoted by reference numeral 605, the voltage supplied to driver circuit 442 does not substantially exceed the predetermined threshold voltage (V_{MAX}). In the example of FIG. 4, the resistance value of resistor 436 is selected to reduce the loop gain of transistor 430 to prevent oscillations and the resistance value of resistor 434 is selected to prevent a leakage current from flowing via zener diode 432.

That is, exemplary regulator 220 is configured to provide a substantially constant voltage to driver 225. When the rectified voltage provided via rectifier 210 falls below a predetermined threshold voltage (V_{T}), the voltage output by regulator 220 decreases. However, as illustrated in the example of FIG. 6, capacitor 440 has a corresponding voltage that exceeds a minimum threshold voltage (V_{T}) and continues to provide energy to driver circuit 442. In addition, when the voltage at node 418 falls below the voltage of capacitor 440, diode 438 prevents current from flowing backwards from capacitor 440 into transistor 424.

As described above, driver circuit 442 is configured to generate a signal that alternately actuates one of transistors 452 and 454 at a carrier frequency. In particular, during the first half of a single cycle of the carrier frequency, the high side output (HO) of driver circuit 442 produces a high side pulse to turn on transistor 452 and transistor 454 is turned off. Typically, the high side pulse and the low side pulse of driver circuit 442 each have corresponding durations that do not exceed half of the time period of a single cycle of the carrier frequency (i.e., a half cycle). When driver circuit 442 turns on transistor 452, transistor 452 couples node 418 to resonant circuit 245 via a low impedance path. On the other hand, during a second half cycle of the carrier frequency, the low side output (LO) of driver circuit 442 produces a low side pulse to turn on transistor 454 and transistor 452 is turned off, thereby coupling the resonant circuit 245 to node 420 via a low impedance path. The example of FIG. 8 illustrates the voltage waveform at node 756, which is denoted by reference numeral 805.

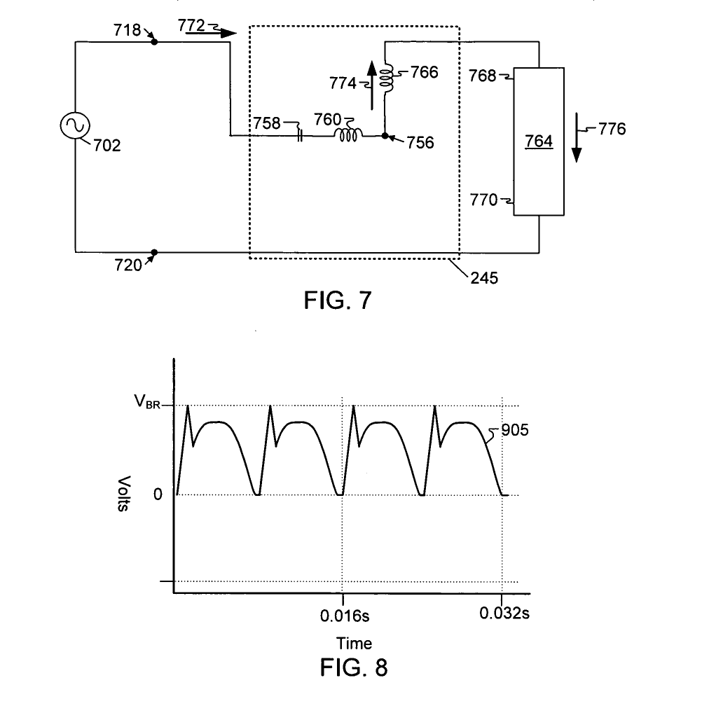

FIG. 7 illustrates an equivalent circuit 700 of the low frequency operation of exemplary circuit 400. Specifically, power source 702 provides a current denoted by 772, which flows into resonant circuit 245 and capacitor 758 limits the current flowing into the inductors 760 and 766. If the light source 764 is not ionized, it cannot conduct current from its first end 768 to its second end 766, which causes a current denoted by reference numbers 774 to be stored in the inductors 760 and 766 as a voltage. However, the inductors 760 and 766 boost the voltage at node 756 based on their turn ratio, thereby causing the voltage at node 756 to exceed the voltage at node 718. As illustrated in the example of FIG. 8, when the voltage at node 756 is substantially equal to a breakdown voltage V_{BR} of light source 764, gases in light source 764 ionize to allow a current denoted by reference numeral 776 is released from the inductors 760 and 766 to flow from the first end 768 to the second end 770 of the light source 764. As a result of current flowing through the light source 764, light source 764 actuates to emit light and the voltage at node 756 becomes substantially equal to the voltage at node 418.

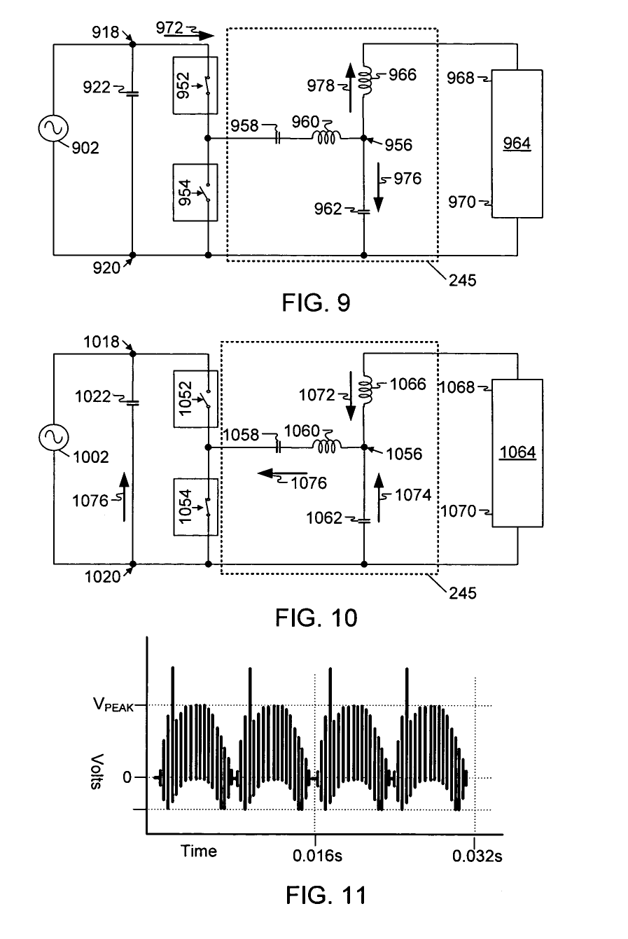

As described above, exemplary circuit 400 also includes a high frequency operation, which will be described in conjunction with FIGS. 9-11. In particular, FIG. 9 illustrates an equivalent circuit 900 during the first half cycle (i.e., one half of a time period of a single cycle of the carrier frequency). As described above, during the first half cycle, driver circuit 942 couples node 918 to resonant circuit 245 via a low impedance path. Initially, a current denoted by reference numeral 972 flows from capacitor 922 and into resonant circuit 245 because transistor 940 is turned off. In the example of FIG. 9, the current leaves inductor 960 and a high frequency current denoted by reference numeral 976 current flows into capacitor 962, which stores a portion of the current as a voltage. If light source 964 is experiencing a breakdown, current 778 flows across light source 764 to cause it to emit light.

The example of FIG. 10 illustrates the operation of exemplary circuit 400 during the second half cycle of the carrier frequency. As described above, during the second half cycle, driver circuit 442 couples node 1020 to resonant circuit 245 via a low impedance path. In response, capacitors 1062 and inductors 1066 discharge the voltage therein as currents denoted by reference numerals 1072 and 1074, respectively. Currents 1072 and 1074 flow into inductor 1060 and charge capacitor 1058 as a voltage, thereby causing resonant circuit 245 to have a negative voltage with respect to second node 1020. As a result, light source 1064 is actuated to visually emit light. After a delay, the capacitor 1058 releases the current as denoted by reference numeral 1076, which flows into node 1020. However, because capacitor 1022 stores substantially no energy, current 1076 flows into the capacitor 1022 from node 1020, which is stored as a voltage therein. At the end of the second half cycle of the carrier frequency, resonant circuit 245 stores substantially no energy.

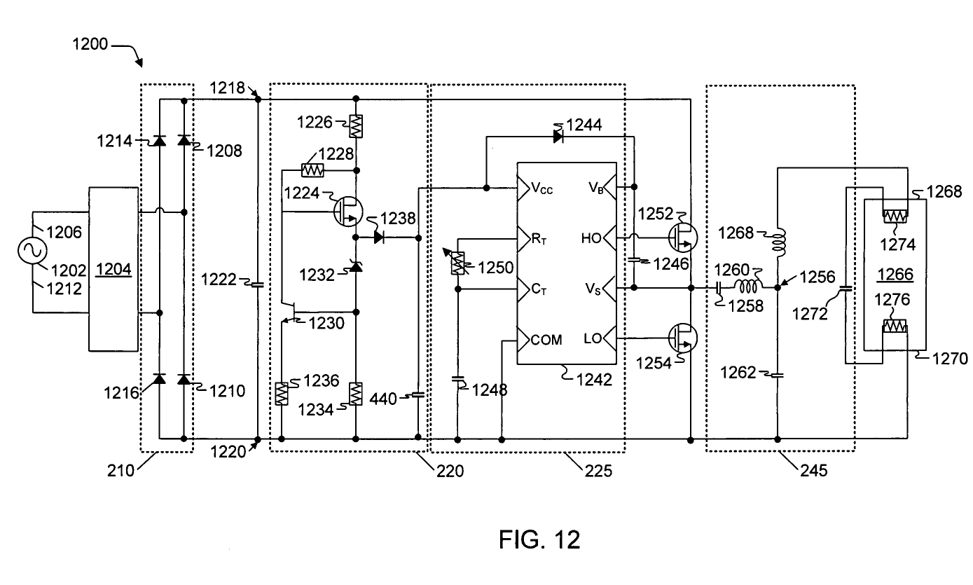

The illustrated example of FIG. 11 illustrates the voltage at node 1056, which is denoted by reference numeral 1105. Specifically, the operation of the exemplary circuit 400 (FIG. 4) causes the voltage at node 456 to alternate between a positive magnitude and a negative magnitude at the carrier frequency. In particular, the ionization of the light source 464 causes the voltage at node 456 to exceed the voltage of node 418 when the light source 464 is not conducting current. When light source 464 does conduct current after it becomes ionized, the voltage at node 456 is substantially equal to the voltage at node 418. Further, the magnitude of the voltage at node 456 is based on the magnitude of the current provided via power source 402 (e.g., 60 Hz, etc.). Thus, exemplary circuit 400 turns the light source 464 (FIG. 2, etc.) on and off twice during each cycle of the carrier frequency and varies the magnitude of the power through light source 464 based on the frequency of power source 402, which is not generally perceptible to the human eye in the illustrated example.

Thus, in the described examples, the magnitude of the voltage at the input of the resonant circuit is substantially similar to the input power provided via the power source. In particular, because the current flowing through the resonant circuit is substantially similar to a sine wave, the crest factor of the illustrated example is generally substantially close to the ideal crest factor, which is the square root of 2 (e.g., 1.7, etc.). In addition, the example ballasts do not require a large electrolytic capacitor used in conventional ballasts to store substantial amounts of low frequency energy because the high frequency current is continually recycled by a non-electrolytic capacitor. Further, the operation of the example ballasts do not require a separate circuit that ionizes the light source at the beginning of the cycle of the line current, thereby reducing the number of components necessary to make the ballast circuit. In the illustrated examples, the second inductor is wound onto the first inductor in the resonant circuit and is configured to boost the voltage, thereby reducing the size of the capacitors required in the resonant circuit. The efficiency of such ballast circuits, based on the value of components selected, generally experience a high efficiency of approximately 90% and a high power factor (e.g., 0.9, etc.). As a result, the examples described herein realize a high power factor correction circuit with a single stage of processing with respect to the power source, thereby making such example ballasts smaller, easier to manufacture, and saving cost by reducing the number of components. In addition, because described examples do not require a large high voltage, low temperature electrolytic capacitor, the lifespan of such ballasts is substantially increased.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

What is claimed is:

1. A ballast circuit, comprising:
a power source coupled to a first node and a second node, the power source having a current that alternates at a line frequency and a first voltage, wherein the first node is coupled to the second node via an energy storage device that stores energy at a first frequency that exceeds the line frequency;
a first switch operable to selectively couple the energy storage device to a resonant circuit via the first node, the resonant circuit having a resonant frequency and being coupled to a light source, wherein the resonant circuit stores energy during a first portion of a cycle of the first frequency; and
a second switch operable to selectively couple the energy storage device to a resonant circuit via the second node, the second switch causing energy stored in the resonant circuit to be substantially stored in the energy storage device during a second portion of the cycle of the first frequency,
wherein the resonant circuit increases the first voltage to a second voltage during a first portion of a cycle of the line frequency.

2. A ballast circuit as defined in claim 1, further comprising a driver circuit to alternately actuate one of the first and second switches at the first frequency.

3. A ballast circuit as defined in claim 1, wherein the resonant circuit comprises:
a first capacitor having a first terminal coupled to the first and second switches;
a first inductor having a large air gap and having a first terminal coupled to a second terminal of the first capacitor;
a second capacitor having a first terminal coupled to the second terminal of the inductor, the second terminal of the capacitor being coupled to the second node; and
a second inductor ( wound on top of the first inductor) having a first terminal being coupled to the second terminal of the inductor and a second terminal of the second inductor coupled to the second node via the light source.

4. A ballast circuit as defined in claim 3, wherein the first capacitor is operable to limit the current provided to the light source.

5. A ballast circuit as defined in claim 4, wherein the first and second capacitors are operable to store a portion of a current provided via the power source during the first portion of the cycle of the first frequency.

6. A ballast circuit as defined in claim 5, wherein the first and second capacitors are operable to discharge the stored current during the second portion of the first frequency.

7. A ballast circuit as defined in claim 6, wherein the first portion of the first frequency is approximately a half cycle of the first frequency and the second portion of the first frequency is approximately a different half cycle of the first frequency.

8. A ballast circuit as defined in claim 3, wherein the first and second inductors are wound on a core and are operable to increase the first voltage to the second voltage until the second voltage is substantially equal to a breakdown voltage of the light source.

9. A ballast circuit as defined in claim 1, wherein a first terminal of the power source is directly coupled to the light source via the resonant network during the first portion of the first frequency and a second terminal is directly coupled to the light source via the resonant network during the second portion of the first frequency.

10. A ballast circuit as defined in claim 1, wherein the energy storage device comprises a capacitor having a capacitance value approximately in the range of 4 to 120 nanofarads per watt of power.

11. (canceled)

12. A ballast circuit as defined in claim 1, wherein the first frequency exceeds the resonant frequency of the resonant network.

13. A ballast circuit as defined in claim 12, wherein the first frequency is a line frequency of a power source.

14. A ballast circuit as defined in claim 13, wherein the light source receives a current having the line frequency and a current having the first frequency.

15. A ballast circuit as defined in claim 1, wherein the light source is selected from one of a fluorescent lamp and a gas discharge lamp.

16. A ballast circuit as defined in claim 1, wherein the first inductor comprises a gapped ferrite core with a primary winding and a secondary winding, wherein the primary winding is operable to create a high frequency resonant energy and the secondary winding is operable to increases the first voltage to a second voltage during the first portion of a cycle of the first frequency.

17. A ballast as defined in claim 16, wherein the gapped ferrite core includes an air gap, wherein the air gap substantially prevents saturation during a peak of a current having the line frequency.

18. A method of powering a ballast circuit, comprising:
increasing a first voltage of a power source to a second voltage in a resonant circuit until the second voltage exceeds a breakdown voltage of a light source during a first portion of a cycle of a line frequency;
storing a high frequency current in an energy storage device as a first voltage, the energy storage device being coupled to a first node and a second node;
selectively coupling the energy storage device to the resonant circuit via the first node for a first time period, wherein coupling the energy storage device to the first node generates a voltage in the resonant circuit to actuate a light source; and
selectively coupling the energy storage device to the resonant circuit via the second node for a second time period, wherein coupling the energy device to the second node generates a voltage in the resonant circuit to actuate a light source and store energy in the energy storage device.

19. A method as defined in claim 18, wherein selectively coupling the energy storage device to a resonant circuit via the first node comprises coupling the resonant circuit to a first terminal of a power source having a line frequency.

20. A method as defined in claim 19, wherein selectively coupling the energy storage device to a resonant circuit via the second node comprises coupling the resonant circuit to a second terminal of the power source.

21-22. (canceled)

23. A method of powering a ballast circuit, comprising:
converting a current of a power source from a first frequency to a second frequency that exceeds the first frequency, the second frequency having a magnitude that alternates at the first frequency;
generating a start voltage via the current in a resonant circuit that causes a light source to allow current to flow from a first end to second end of the light source, wherein the resonant circuit generates the start voltage during a first portion of the first frequency;
storing a high frequency energy in a resonant circuit coupled to a light source during a first half cycle of the second frequency, wherein storing the energy causes the light source to emit a light; and
storing the high frequency energy in an energy storage device coupled to the resonant circuit during a second half cycle of the second frequency,
wherein, after the first portion of the first frequency, storing the energy in the resonant circuit actuates the light source.

24. (canceled)
